(19) United States
(12) Patent Application Publication
(10) Pub. No.: US 2009/0201298 A1
(43) Pub. Date: Aug. 13, 2009

(54) System and method for creating computer animation with graphical user interface featuring storyboards

(76) Inventor: Jaewoo Jung, Palo Alto, CA (US)

Correspondence Address: Patent Office of Dr. Chung S. Park, P.O. Box 62312, Sunnyvale, CA, 94088-2312, US

(21) Appl. No.: 12/322,569

(22) Filed: Feb. 4, 2009

Related U.S. Application Data
(60) Provisional application No. 61/065,093, filed on Feb. 8, 2008.

(51) Int. Cl. G06T 13/00; G06F 3/048; G06Q 30/00

(52) U.S. Cl. 345/473; 715/751; 705/14

(57) ABSTRACT

Systems, methods, and computer readable media for customizing a computer animation. A custom animation platform prepares a storyboard including at least one customizable storyboard item and one or more replacement storyboard items configured to replace the customizable storyboard item. Then, the custom animation platform sends the storyboard and the replacement storyboard items to an interactive device via a network to thereby cause a user of the device to select one of the replacement storyboard items. The custom animation platform receives user data including the user's selection from the device and generates a computer animation based on the user data.

### CROSS REFERENCE TO RELATED APPLICATIONS

This application claims the benefit of U.S. Provisional Applications No. 61,065,093 entitled “System and method for customizing computer animation with graphical user interface featuring storyboards,” filed on Feb. 8, 2008, which is incorporated herein by reference in its entirety.

### BACKGROUND OF THE DISCLOSURE

The present invention generally relates to computer animation and, more particularly, to systems and methods for creating computer animations with graphical user interface featuring storyboards.

Advancements in computer hardware and software technologies in recent decades have made development and production of computer animations easier and faster each year. For an example, Mark Henne et al. paper discloses that the first feature film produced entirely using a computer animation technology took a major animation studio several years of effort in early 1990's. (See Mark Henne, Hal Hickel, Ewan Johnson, and Sonoko Konishi, “The Making of Toy Story,” COMPCON Spring 1996-41st IEEE International Computer Conference Proceedings, pages 463-468, 1996). In comparison, John Godwin et al. <URL: www.idlecreations.com/taleofrock/, 2007> discloses that a computer animation film was produced by two students within seven months in 2006 as a thesis project.

Such advancements have been possible partly due to many attempts to provide easy to use tools for creating computer animation. Thus, there is a need for systems and methods to further enable persons to easily create computer animation.

### SUMMARY OF THE DISCLOSURE

In one embodiment of the present invention, a method for customizing a computer animation includes the steps of: preparing a storyboard including at least one customizable storyboard item; preparing one or more replacement storyboard items configured to replace the customizable storyboard item; sending the storyboard and the replacement storyboard items to a device via a network to thereby cause a user of the device to select one of the replacement storyboard items; receiving user data including the user's selection from the device; and causing a computer processor to generate a computer animation based on the user data.

In another embodiment of the present invention, a method for generating a computer animation via network includes the steps of: receiving at least one user interface that includes a storyboard having at least one customizable storyboard item via network; displaying the user interface on a display; displaying one or more replacement storyboard items configured to replace the customizable storyboard item on the display; causing a user to select one of the replacement storyboard items; sending user data including the user's selection; and sending a request to generate a computer animation based on the user data; and receiving and displaying the computer animation on the display.

In yet another embodiment of the present invention, there is provided a computer readable medium storing one or more sequences of pattern data for customizing a computer animation, wherein execution of one or more sequences of pattern data by one or more processors causes the one or more processors to perform the steps of: preparing a storyboard including at least one customizable storyboard item; preparing one or more replacement storyboard items configured to replace the customizable storyboard item; sending the storyboard and the replacement storyboard items to a device via a network to thereby cause a user of the device to select one of the replacement storyboard items; receiving user data including the user's selection from the device; and generating a computer animation based on the user data.

In still another embodiment of the present invention, there is provided a computer readable medium storing one or more sequences of pattern data for generating a computer animation via network, wherein execution of one or more sequences of pattern data by one or more processors causes the one or more processors to perform the steps of: receiving at least one user interface that includes a storyboard having at least one customizable storyboard item via network; displaying the user interface on a display; displaying one or more replacement storyboard items configured to replace the customizable storyboard item on the display; causing a user to select one of the replacement storyboard items; sending user data including the user's selection; and sending a request to generate a computer animation based on the user data; and receiving and displaying the computer animation on the display.

In further another embodiment of the present invention, a computer system includes a custom animation platform adapted to: prepare a storyboard including at least one customizable storyboard item; prepare one or more replacement storyboard items configured to replace the customizable storyboard item; send the storyboard and the replacement storyboard items to a device via a network to thereby cause a user of the device to select one of the replacement storyboard items; receive user data including the user's selection from the device; and generate a computer animation based on the user data.

In yet further another embodiment of the present invention, a computer system includes: a processor adapted to receive at least one user interface that includes a storyboard having at least one customizable storyboard item via a network; and a display for displaying the user interface and one or more replacement storyboard items configured to replace the customizable storyboard item, wherein the processor is further adapted to cause the user to select one of the replacement storyboard items, send user data including the user's selection, send a request to generate a computer animation based on the user data, and receive the computer animation and wherein the display is further adapted to display the computer animation.

### BRIEF DESCRIPTION OF THE DRAWINGS

FIG. 1 shows a system environment in accordance with one embodiment of the present invention;

FIG. 2 shows an exemplary world wide web page (or, shortly, page, hereinafter) representing a home of a graphical user interface that might be displayed on an interactive device of the system in FIG. 1;

FIG. 3 shows an exemplary my videos page that might be displayed on an interactive device of the system in FIG. 1;

FIG. 4 shows an exemplary storyboard editing graphical user interface page that might be displayed on an interactive device of the system in FIG. 1;

FIG. 5 shows an exemplary editing summary page that might be displayed on an interactive device of the system in FIG. 1;

FIG. 6 shows an exemplary preview/order page that might be displayed on an interactive device of the system in FIG. 1;

FIG. 7 shows animation pre-production items that might be included in an animation created by the system in FIG. 1;

FIG. 8 shows a flow chart illustrating exemplary steps that may be carried out by a computer animation engine of FIG. 1 to generate a computer animation in accordance with another embodiment of the present invention;

FIG. 9 shows a flow chart illustrating exemplary steps that may be carried out by a custom animation platform of FIG. 1 to generate a computer animation with a graphical user interface featuring storyboards in accordance with yet another embodiment of the present invention; and

FIG. 10 shows an embodiment of a computer of a type that might be employed in the system environment of FIG. 1 in accordance with still another embodiment of the present invention.

### DETAILED DESCRIPTION OF THE PREFERRED EMBODIMENTS

The following detailed description is of the best currently contemplated modes of carrying out the invention. The description is not to be taken in a limiting sense, but is presented merely for the purpose of illustrating the general principles of the invention, since the scope of the invention is best defined by the appended claims.

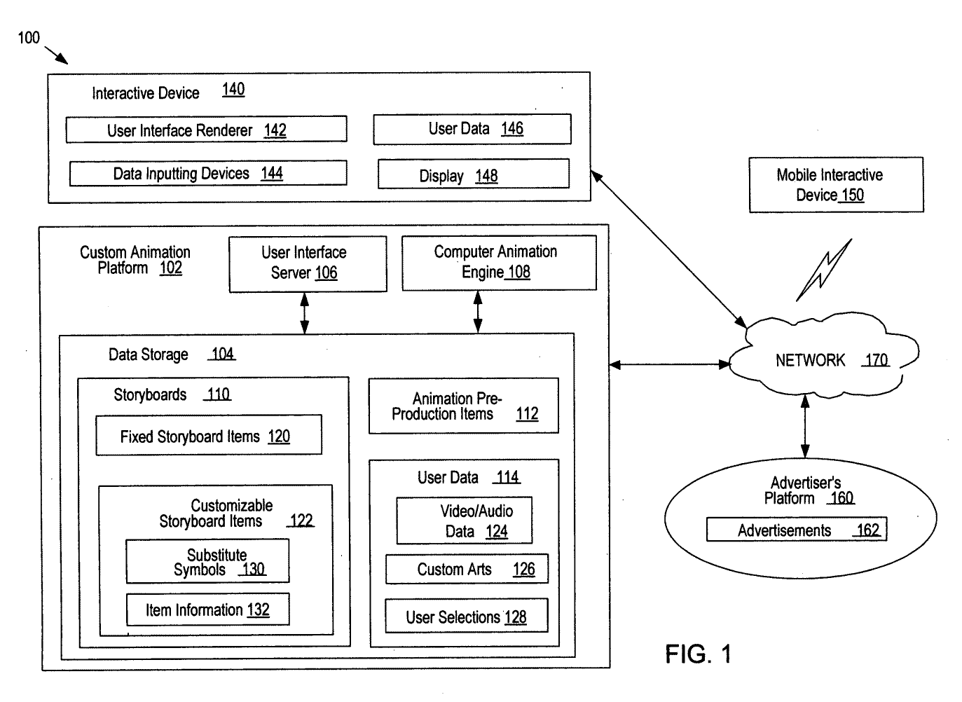

Referring now to FIG. 1, there is shown at 100 a schematic diagram of a system environment in accordance with one embodiment of the present invention. As depicted, the system 100 may include a custom animation platform 102; an interactive device 140; a mobile interactive device 150; and an advertiser's platform 160, which may be connected to a network 170. The network 170 may include any suitable connections for communicating electrical signals therethrough, such as WAN, LAN, or the Internet.

The custom animation platform 102 includes a user interface server 106; a computer animation engine 108; and a data storage 104 coupled to the user interface server 106 and a computer animation engine 108. The data storage 104 stores animation pre-production items 112, user data 114, and storyboards 110. The custom animation platform 102 may be a computer or any other suitable electronic device for running the user interface server 106 and the computer animation engine 108 therein. For the purpose of illustration, the data storage 104 is shown to be included in the custom animation platform 102. However, it should be apparent to those of ordinary skill that the data storage 104 may be physically located outside the custom animation platform and coupled to the user interface server 106 and the computer animation engine 108 directly or via the network 170.

The user interface server 106 sends instructions and data to construct and operate a user interface to the interactive device 140, and receives the user data 146 from the interactive device 140, directly or through the network 170. The interactive device 140 contains a user interface renderer 142, data inputting devices 144, user data 146 and a display 148. A typical interactive device 140 is a computer, where the user interface renderer 142 is an Internet browser running on the computer, the data inputting devices 144 are a keyboard, a mouse, a camera, a microphone and other auxiliary input devices such as a scanner, a graphical tablet, touch sensitive monitor, etc. connected to the computer. The user data 146 reside in memory bank of the computer, and the display 148 is a display monitor connected to the computer.

The user data 146, which is the same as user data 114, include video/audio data 124, custom arts 126, and user selections 128. The video/audio data 124 are what a user of the interactive device 140 captures with video and audio data inputting devices 144, such as video greetings of self. Alternatively, the video/audio data 124 may include all or parts of the user generated data through the data inputting devices 144, such as keyboard strokes, mouse movements, etc. The custom arts 126 may include art works generated and submitted by the user, and/or by third parties, such as computer animation freelancers, students, studios, amateur enthusiasts, etc. By way of example, the custom art 126 may include a digital portrait of the user, digital photos, and drawings. The video/audio data 124 and the custom art 126 may be sent to and stored in the data storage 104 such that both may be incorporated into animations generated by the computer animation engine 108, which will be described in detail below with reference to FIG. 8. The user selections 128 contains users interaction data with the user interface in the interactive device 140, such as customizations on the storyboards made by the user. The interactive device 140 may be network enabled video gaming consoles, media players, and personal navigators. The mobile interactive device 150 is the interactive device 140 in a mobile form.

The advertiser's platform 160, which is connected to the network 170, includes a storage for advertisements 162 and sends the advertisements 162 to the custom animation platform 102 via the network 170. The advertisements 162 may be incorporated into the computer animations generated by the animation engine 108, and displayed to a user of the interactive device 140 and the mobile interactive device 150. In one embodiment, the advertisement can be incorporated into the computer animation as a product placement, a trademark placement, a virtual billboard, a hypertext link, or an animation. Advertisement providers can be any person, corporate, company or partnership that provides advertisements to the custom animation platform 102. Alternatively, the advertiser's platform 160 may send the advertisements 162 to the interactive device 140 and the mobile interactive device 150 through the network 170, without going through the custom animation platform 102.

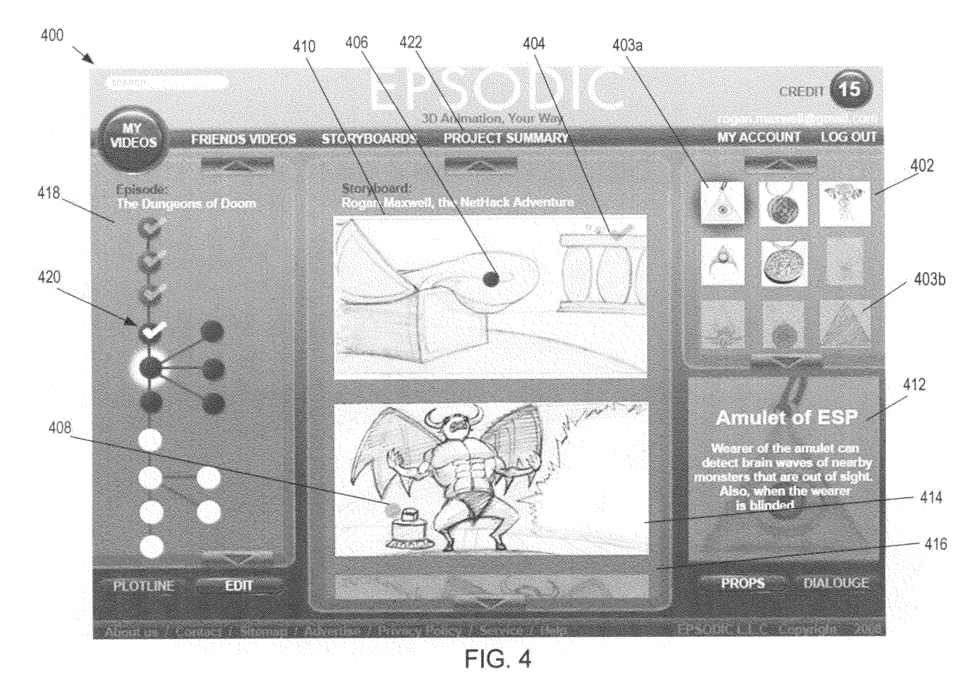

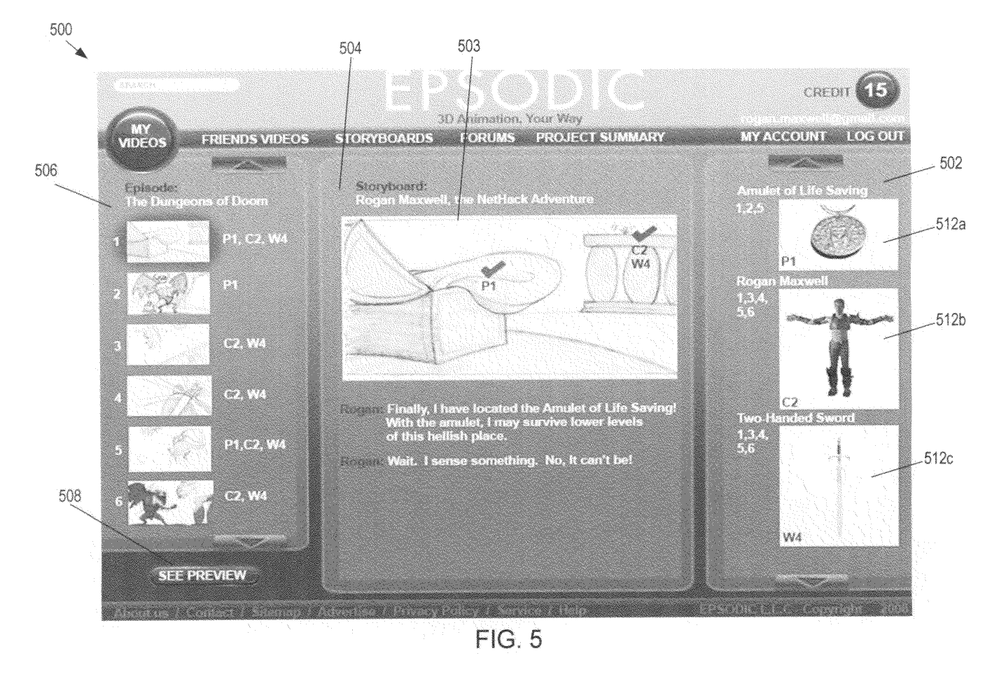

The storyboards 110 include a series of illustrations, with or without text, to be displayed in sequence for the purpose of previsualizing an animation before it is produced. Each storyboard contains fixed storyboard items 120 and customizable storyboard items 122, where the customizable storyboard items 122 include substitute symbols 130 and item information 132. The customizable storyboard items 122 will be described in detail below with reference to FIG. 4 and FIG. 5. In the preferred embodiment, a small group of storyboards are referred to as an episode of an animation. Each episode tells a segment of the animation.

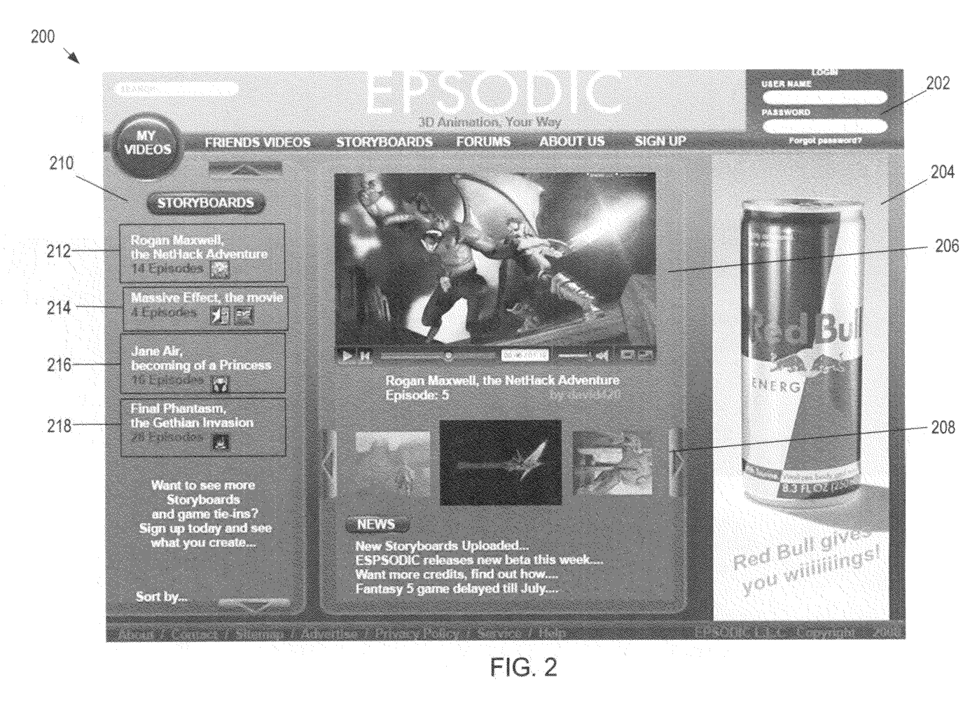

By way of example, the user interface server 106 may send Hyper Text Markup Language script to the user interface renderer 142, to form interactive world-wide-web pages shown in FIG. 2 to FIG. 6, and receive the user data 146 through the network 170. In FIG. 2, there is shown at 200 an exemplary world-wide-web page representing a home of a graphical user interface that might be displayed on the display 148. As depicted, the home page 200 may include a user log-in area 202; an advertisement featuring area 204; a sample animation play area 206; a sample animation selection area 208; and a storyboard list area 210 with storyboards, such as ‘Rogan Maxwell, the NetHack Adventure’ 212, ‘Massive Effect, the movie’ 214, ‘Jane Air, becoming of a Princess’ 216, and ‘Final Phantasm, the Gethian Invasion’ 218, for instance.

In the user log-in area 202, a user of the graphical user interface on the interactive device 140 or on the mobile interactive device 150 logs in with a user name and a password. A new user may sign up to set a user name and a password that may be subsequently stored in the user data 114 and/or 146. In the advertisement featuring area 204, different types of advertisements, such as a banner advertisement with an active hyper link, may be shown and updated periodically. The advertisement featuring area 204 displays advertisements 162 received from the advertiser's platform 160.

In the sample animation selection area 208, images of available sample animations may be shown, where the animations are previously created by the custom animation engine 108. Each image may include the representative scene of a sample animation. When a user selects one of the images in the sample animation selection area 208, the animation corresponding to the selected image is displayed in the sample animation play area 206. In the storyboard list area 210, a list of animations to be generated based on customizable storyboards using the graphical user interface is shown.

As discussed above, each episode tells a segment of the animation. For example, there are 14 episodes in ‘Rogan Maxwell, the NetHack Adventure’ 212 in FIG. 2. Each episode contains a group of customizable storyboards to show a sequence of events in the episode. The user customizes all or parts of the storyboards in the animation using the graphical user interface to request custom animations to be made.

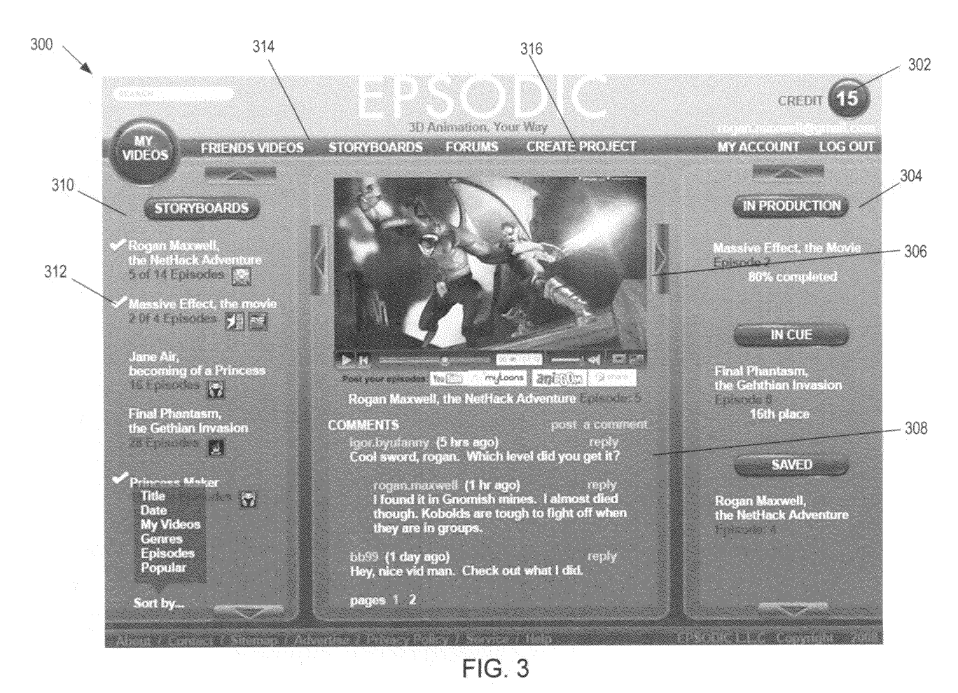

When a user logs in, the user is directed to a my videos page 300, as shown in FIG. 3. The my videos page 300 may include a credit balance area 302; a production summary area 304; a customized animation play area 306; a comment area 308; a storyboard customization summary area 310; a customized animation indicator 312; a site navigation menu bar 314; and a create project menu item 316.

In the credit balance area 302, balance of a virtual credit (or, shortly, credit, hereinafter) for the current user is displayed. In one embodiment, some amount of credit may be given to the user during the first time sign-up process. Additional credit may be purchased by the user using the real currency. Credit is used by the user to purchase replacement storyboard items, to generate previews, and to generate customized animations. Details of replacement storyboard items will be described in details below with reference to FIG. 4.

In the production summary area 304, details of custom animation in production, in cue and saved customizations may be shown. When the user selects an episode of an animation to customize storyboards in the episode, partially customized episode can be saved. When the user finishes customization of storyboards in the episode, production of a customized animation using the storyboards can be requested. Once requested, the episode containing the customized storyboards enters a production cue, waiting for its turn to be made into an animation. Once the custom animation is in production, its progress is reported in the summary area 304.

In the storyboard customization summary area 310, the list of available customizable animation is shown, with information on how many episodes in each animation are customized by the user. The customized animation indicator 312, which is in a shape of a check mark, indicates at least one episode for the indicated animation is customized and made into an animation, and is ready to be played. In the customized animation play area 306, one of the user's customized animation episodes that are listed in the storyboard customization summary area 310 is played. The user can select which episode to play by clicking a name of animation in the storyboard customization summary area 310 then select among the playable episodes for the animation using navigation buttons in 306. In the comment area 308, feedbacks from other users and responses of the user for the animation playing in the play area 306 are displayed.

By clicking the menu item in the site navigation menu bar 314, the user may move between web pages. The create project menu item 316 moves the user to the storyboard editing graphical user interface page 400 in FIG. 4 when clicked. Also, when the user selects an animation to customize in the storyboard customization summary area 310, the user moves to the page 400 in FIG. 4.

In FIG. 4, the storyboard editing graphical user interface page (or, shortly, editing GUI page, hereinafter) 400 is shown. The editing GUI page 400 may include a replacement storyboard item area 402; a selectable replacement storyboard item (or, shortly, replacement item or replacement) 403a; a grayed-out, non-selectable replacement storyboard item 403b; editing point indicators 404, 406 and 408; storyboards 410 and 414; a replacement storyboard item description area 412; a storyboard navigation area 416 including the storyboards 410 and 414; an episode navigation area 418; a group of episodes in the animation 420; and a project summary menu item 422.

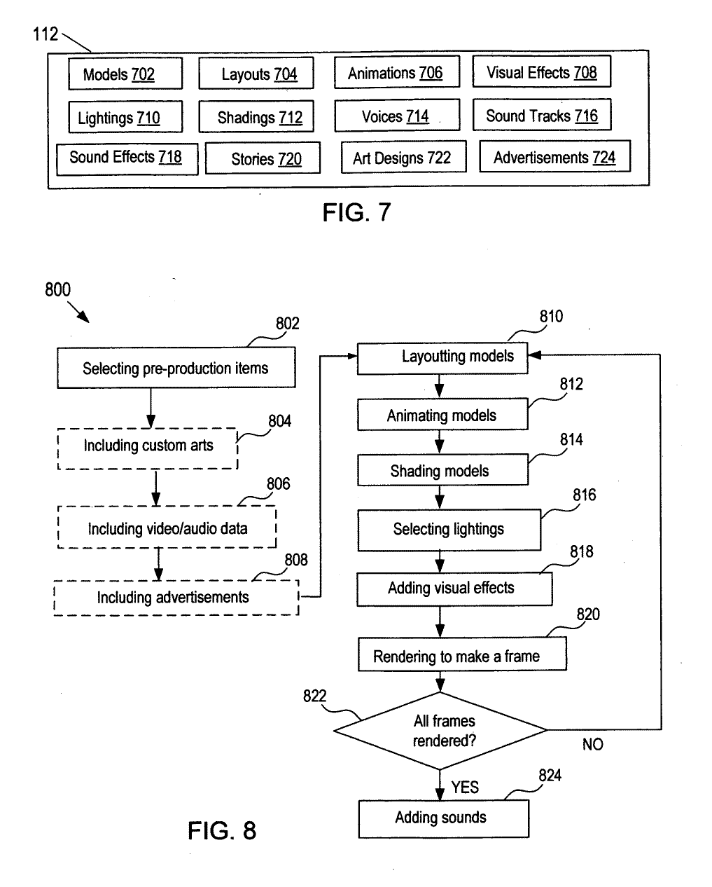

The editing GUI page 400 displays the storyboards 110 shown in FIG. 1. As discussed above, the storyboards 110 contain the fixed storyboard items 120 and the customizable storyboard items 122. The customizable storyboard items 122 refer to parts of a storyboard that can be changed by the user. Followings are examples of customizable storyboard items in a storyboard: characters; character details, such as clothing/armors, hair color, etc.; objects used by the character; trifling articles; backgrounds; shape, size and color of the items so far; camera parameters including its placement; mood lightings; dialogs; and associated sounds. Alternatively, customizable storyboard items may include all or parts of the animation pre-production items 112. The animation pre-production items 112 will be described in detail below with reference to FIG. 7. A user can replace a customizable storyboard item by selecting one from available replacement storyboard items, which are represented by substitute symbols 130, and described with associated item information 132. The fixed storyboard items 120 refer to parts of the storyboard that cannot be changed by the user.

Examples of the storyboards 110, the fixed storyboard items 120 and the customizable storyboard items 122 are shown in FIG. 4. The editing point indicators 404, 406 and 408 show exemplary customizable storyboard items in exemplary storyboards 410 and 414 that the user can customize. When the user selects an editing point, a table of replacements for the selected customizable storyboard item is displayed in the replacement item area 402. In the replacement item area 402, the user can select a replacement item, represented by the substitute symbols 130 related to the indicated part of the storyboard. Some items, such as the selectable replacement storyboard item 403a, can be selected by the user, but other items, such as the grayed-out, non-selectable replacement storyboard item 403b, may not be selected by the user.

To be able to select grayed-out items such as 403b, the user may purchase them using credit. Alternatively, the user may play a game to unlock such items. As an example, the customizable animation ‘Rogan Maxwell, the NetHack Adventure’ is closely related to the game ‘NetHack’ as the animation is based on the game's premises. Therefore, the user can obtain one or more of the grayed-out items 403b during a game play, and use the play data to unlock the items to become selectable. As such, both the in-game pre-production items and the non-game pre-production items of the game the user play can be used as replacement items for the customizable storyboard items 122. The detailed description of the in-game pre-production items and non-game pre-production items can be found in U.S. patent application Ser. No. 12/006,350, entitled “Systems and methods for generating personalized computer animation using game play data,” filed on Dec. 31, 2007, which is herein incorporated by reference in its entirety. The indicator 404 shows the user already made non-default selections for the customizable storyboard item indicated by the editing point.

The replacement storyboard item description area 412 shows the item information 132 in FIG. 1 for each item in the replacement items area 402 including its price in credit for non-selectable items. The storyboard navigation area 416 shows storyboards to be customized, showing both the fixed storyboard items 120 and the customizable storyboard items 122 from the FIG. 1 and features methods to move around all storyboards in an episode. The group of episodes 420 in the animation, which is “The Dungeons of Doom” in the present case, represents episodes in the customizable animation. Each circle in the group 420 represents an episode of the animation. The episode navigation area 418 allows the user to choose an episode from the group 420, to customize storyboards in the chosen episode in the page 400. The group of episodes 420 includes different types of episodes. Using a vertical orientation, the top three circles with check marks represent customized episodes that are already made into animations. The user can re-customize these episodes if desired. The fourth circle from the top with a check mark represents a customized episode that the user requested to be made into an animation. The fifth and sixth circles in the middle without check marks represent available episodes for customization. The white circles at the lower part of the group 420 represent episodes, which the user cannot customize yet. A white circle episode may turn into a colored one if an episode prior to it is customized by the user. In the present example, the user customizes the fifth episode that includes the storyboards 410 and 414.

A white circular background of the fifth circle indicates that current episode the user is customizing, including the storyboards 410 and 414. The fifth circle shows three branches and the user can select one of the three branches to customize in parallel to the fifth episode. For instance, the branches represent three different adventures that the user can choose to enter before the sixth episodes, using the vertical orientation.

Following is an example of a storyboard customization by the user by using the editing GUI shown in FIG. 4. First, the user clicks on the editing point 406, which is an amulet of Extra-Sensory Perception, ESP, by a default. Following the click, replacement items area 402 shows replacement amulets that can be selected by the user, and ones that are not selectable as well. The user purchases a non-selectable item, an amulet of life saving, to make it selectable. The user then selects it to be placed in a custom animation, instead of the default amulet. The user can also edit dialogs (not shown in FIG. 4) in the storyboards 410 and 414.

Instead of selecting replacement items on the graphical user interface, the user can create and use one's own replacement items, including the replacement items' substitute symbols 130, item information 132 and related animation pre-production items 112. For example, for a customizable storyboard item, the user may draw substitute symbols of replacement items, write item description for each item and build computer models for each item for pre-production using software tools, that are provided as a part of the graphical user interface and/or separate from the interface. Furthermore, the user can designate fixed storyboard items 120 in a storyboard as customizable storyboard items 122, and create and use one's own replacement items, including their substitute symbols 130, item information 132 and related animation pre-production items 112, or select replacement items and their substitute symbols 130, item information 132 and related animation pre-production items 112, from the ones created by third parties such as studios, freelancers, amateur enthusiasts, students of graphics arts, etc. As still another option, the user may use or incorporate data from the data inputting devices 144 as replacement items, substitute symbols 130, item information 132 and animation pre-production items 112, for a selected customizable storyboard item. For example, the user may select a customizable item, such as a character in a storyboard, then use one's own digital photo captured through a camera, description typed on a keyboard, and a computer model drawn on a graphical tablet, as a substitute symbol, item description, and a pre-production computer model for the character, respectively. As yet another option, the user may use voice and sound, captured through a microphone, to replace parts or all of dialogs and pre-production sounds in a storyboard. Furthermore, the user may capture video and/or audio of a person's acting, to be used as a replacement item. For example, the user may capture video and audio of a person's acting as a monster, and use it to replace a monster in a storyboard, which is a customizable storyboard item. Although it is not specified on the present embodiment, it should be apparent to those of ordinary skill that the graphical user interface, including the editing GUI shown in FIG. 4, can be used by a single person, or by multiple people sharing the same interactive session concurrently through one or more interactive device 140, or mobile interactive device 150 connected through the network 170. Once all customizations that the user wanted are done, the user may move to the editing summary page 500 in FIG. 5 by clicking on the project summary menu item 422. In the multi-user case, a concession is drawn among the users to proceed to the editing summary page 500 in FIG. 5.

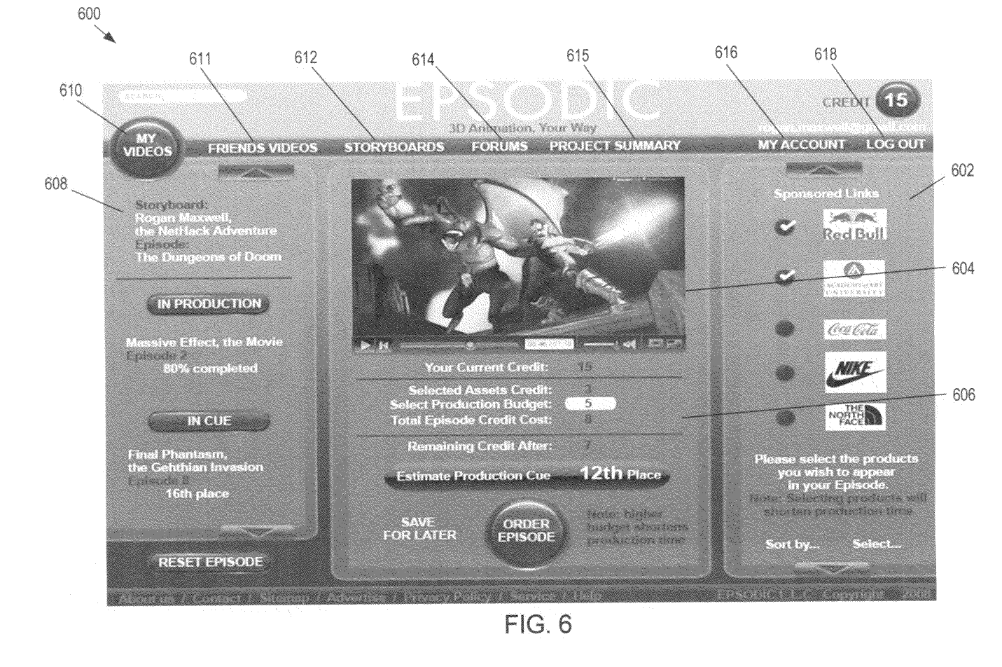

As depicted, the editing summary page 500 may include a customized storyboard items viewing area 502; a storyboard review area 504; a customization summary view area 506; and a see preview navigation button 508. In the customization summary view area 506, the user can see most of the storyboards in a customized episode with information on selected custom storyboard items for each storyboard. The user can select a storyboard from the summary view area 506 to review details of customization. For example, the user selects the first customized storyboard in the summary view area 506 so that the selected storyboard 503 is displayed in the storyboard review area 504. In the storyboard review area 504, details of the selected customized storyboard 503 in the episode, including custom selections made for each editing point in the storyboards and edited dialog for the storyboard, are displayed. In the custom storyboard items viewing area 502, details of items 512a-512c included in the customized storyboard 503 are shown. After the review, the user may proceed to order preview of the customized episode and to order the episode to be made into an animation using credit. The see preview navigation button 508 moves the user to a preview/order page 600 in FIG. 6 when clicked by the user.

As depicted, the preview/order page 600 may include a sponsored message opt out area 602; a preview viewing area 604; an animation order area 606; an episode information area 608; a navigation button to my videos page 610; a friends videos menu item 611; a storyboards menu item 612; a forums menu item 614; a project summary menu item 615; a my account menu item 616; and a log out menu item 618.

In the sponsored message opt out area 602, the user can select not to include such messages into the custom animation. Sponsored messages, which are advertisements 162 from the advertiser's platform 160 in FIG. 1, may be incorporated into the custom animation in suitable forms, such as product placement in the animation, superimposed advertisements on the animation, and hypertext links on the animation, for instance. Incorporating the sponsored message may speed up production of the custom animation requested by the user. In the preview viewing area 604, a preview of the customized episode is displayed. Preview may be presented as still shots of the custom animation, a segment of the custom animation, the custom animation in low quality, and other suitable formats.

In the animation order area 606, the user can review the amount of credit used customizing the episode, and may select budget to request production of the custom animation with. The budget is paid by the user, with the user's credit. Once the budget is entered, an estimate of production cue placement is displayed. Higher budget may result in advancing the cue placement forward in the cue. In the episode information area 608, information of the customized episode is displayed.

The followings describe results when the user clicks on each of the navigation button to my videos page 610, the friends video menu item 611, the storyboards menu item 612, the forums menu item 614, the project summary menu item 615, the my account menu item 616, and the log out menu item 618.
The navigation button to my videos page 610: the user moves to the my videos page 300.
The friends videos menu item 611: the user moves to the friends videos page where customized animations of other users can be watched. For brevity, the friends videos page is not shown in the present drawings.
The storyboards menu item 612: the user moves to the my videos page 300.
The forums menu item 614: the user moves a forum page to leave their opinions about the web site. For brevity, the forum page is not shown in the present drawings.
The project summary menu item 615: the user moves to the editing summary page 500.
The my account menu item 616: the user moves to the my account page to take care of personal information, such as user name and password. For brevity, the my account page is not shown in the present drawings.
The log out menu item 618: the user logs out from the web site.

It should be apparent to those of ordinary skill in the art that FIGS. 2-6 show exemplary pages to be displayed on the display 148 (shown in FIG. 1). As such, the layouts of the items included in the FIGS. 2-6 may be varied without deviating from the spirit of the present invention. Furthermore, additional items, such as buttons, may be added to the FIGS. 2-6 to provide additional functions to the pages therein.

FIG. 7 shows detailed description of the animation pre-production items 112 in FIG. 1. The animation pre-production items 112 refer to, but are not limited to, all or part of elements that are used in computer animation development and production processes and are prepared prior to the production of actual animation. As depicted in FIG. 7, the animation pre-production items 112 include pre-production items of a computer animation that might be included in the custom animation platform 102, where the items include, but are not limited to, models 702, layouts 704, animations 706, visual effects 708, lightings 710, shadings 712, voices 714, sound tracks 716, sound effects 718, stories 720, art designs 722, and advertisements 724.

The models 702 of a computer animation include characters (or, avatars), stages for scenes, tools used by the characters, backgrounds, trifling articles, a world in which the characters live, or any other elements used for the visual presentation in the animation. The layouts 704 include information related to the arrangements of the models 702 in the animation scenes. The animations 706 refer to successive movements of each model appearing in a sequence of frames. A stop-motion animation technique may be used to create animation by physically manipulating real-world objects and photographing them one frame of film at a time to create the illusion of movement of a typical clay model. In one embodiment of the present invention, several different types of stop-motion animation technique, such as graphic animation, may be applied to create the animations 706 of each model. By the animations 706, characters are brought to life with movements.

The visual effects 708 refer to visual components integrated with computer generated scenes in order to create more realistic perceptions and intended special effects. The lightings 710 refer to the placement of lights in a scene to create mood and ambience. The shading 712 is used to describe appearance of each model, such as how light interacts with the surface of the model at a given point and/or how the material properties of the surface of the model vary across the surface. Shading can affect the appearance of the models, resulting in intended visual perceptions. The voices 714 includes voices of the characters in the animation. The sound tracks (or, just tracks) 716 refers to audio recordings used in the animation. The sound effects 718 are artificially created or enhanced sounds, or sound processes used to emphasize artistic or other contents of the animation. Hereinafter, the term sound collectively refers to the voices 714, the sound tracks 716, and the sound effects 718. Also, the terms sound and audio content are used interchangeably hereinafter.

The stories 720 contain possible story paths and endings for each animation. The art designs 722 contain overall art direction for each animation. The advertisements 724 are the advertisements 162 from the advertiser's platform 160 in FIG. 1.

It is noted that, in FIG. 7, the animation pre-production items 112 are shown to have twelve types of items for the purpose of illustration. However, it should be apparent to those of ordinary skill that FIG. 7 does not show an exhaustive list of animation pre-production items, nor does it imply that the entire animation pre-production items can be grouped into twelve types. For instance, the animation pre-production items 112 may also include rendering parameters (not shown in FIG. 7).

As discussed above, the user data 114 are same as the user data 146, received from the interactive device 140, and the mobile interactive device 150. The computer animation engine 108 generates computer animation with the animation pre-production items 112 and the user data 114. FIG. 8 shows a flow chart 800 illustrating exemplary steps that might be carried out in the computer animation engine 108 to generate animation in accordance with another embodiment of the present invention. The process begins in a state 802. In the state 802, the user selections 128 are used to choose necessary elements from the animation pre-production items 112 to create a computer animation based on the user's choices. For instance, the user's choice may include selection of a replacement storyboard item, say 403a. Optionally, the selected replacement storyboard item may be transfigured to enhance theatrical effects. For example, the custom animation platform 102 may perform an analysis on the frequency of the user's selection of the selected replacement storyboard item, say the sword 512c. If the analysis indicates that the user chooses the sword 512c more frequently than other weapons in the battle scenes, the image of the sword may be transfigured to show higher wear and tear than other weapons.

Once the items are chosen, optional steps 804, 806, and 808 for incorporating the custom arts 126, the video/audio data 124 and the advertisement 162 to the chosen animation pre-production items, respectively, may be performed. Information of the custom arts 126, the video/audio data 124 and the advertisement 162 used in the states 804, 806, and 808 may be received from the interactive device 140 and the mobile interactive device 150 via the network 170. Next, the process proceeds to a state 810.

In the state 810, to create a frame, the models 702 are arranged according to the layouts 704. Subsequently, in states 812 and 814, animations 706 and shadings 712 are applied to the models in the frame. The art design 722 may be used to guide the steps 810 and 814. Then, the lightings 710 are selected for the frame in a state 816, and the visual effects 708 are added to the frame in a state 818. Next, the frame is rendered in a state 820. Hereinafter, the term rendering refers to taking a snap shot of a frame. In a decision block 822, a determination is made as to whether all frames of the computer animation have been rendered. If the answer to the decision block 822 is negative, the process proceeds to the state 810 and repeats to the states 820 to prepare and render another frame. Otherwise, the process proceeds to a state 824 to add sounds, such as the voices 714, the sound tracks 716, and the sound effects 718. It is to note that the rendering in the state 820 is computationally intensive process, and may be done on a third party rendering platform

It will be appreciated by those of the ordinary skill that the illustrated process in FIG. 8 may be modified in a variety of ways without departing from the spirit and scope of the present invention. For example, various portions of the illustrated process may be combined, be rearranged in an alternate sequence, be removed, and the like. In addition, it should be noted that the process may be performed in a variety of ways, such as by software executing in a general-purpose computer, by firmware and/or computer readable medium executed by a microprocessor, by dedicated hardware, and the like. For another example, the art design 722 may have changed after the animation is rendered. A revised animation may be rendered then by repeating steps 802 to 824.

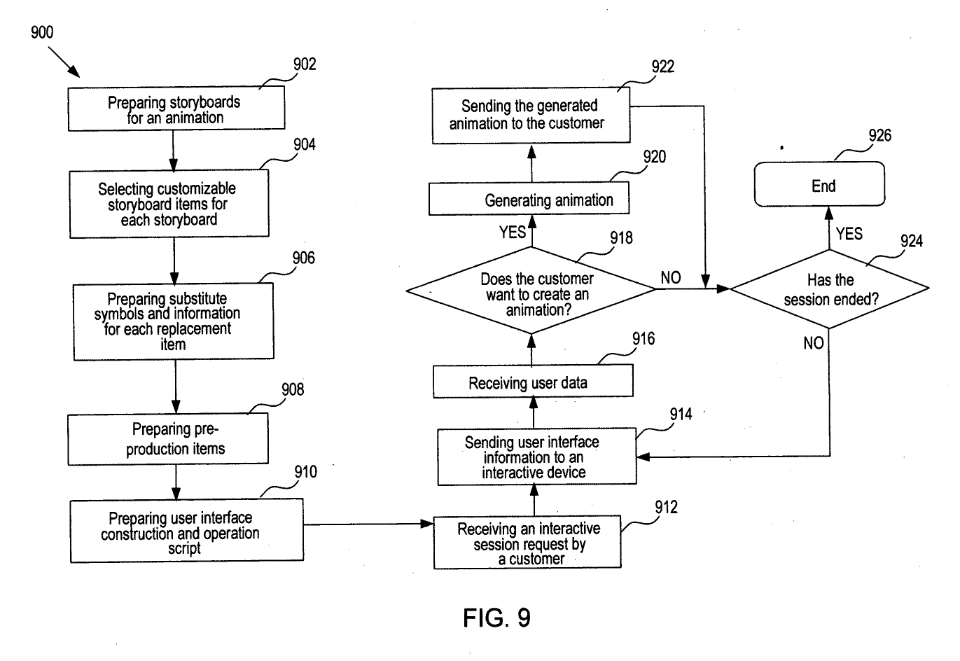

In FIG. 9, a flow chart 900 illustrating exemplary steps that may be carried out by the custom animation platform 102 (shown in FIG. 1) to generate computer animation with a graphical user interface featuring storyboards in accordance with another embodiment of the present invention. The process starts in a state 902. In the state 902, storyboards of an animation is prepared. Typically, storyboards are drawn by hands, then stored in a digital format. Alternatively, panels from an existing cartoon or frames from an existing film can be used as storyboards. For the purpose of an example, storyboards of an animation of a snow man wearing a black top hat, with waving hands are assumed to be generated. Then, in a state 904, customizable parts of each storyboard are selected. Using the same example, the top hat is selected to be customized by substitution. The process then goes to a state 906. In the state 906, for each replacement item for a customizable storyboard item, a substitute symbol and associated item information are prepared. One or more replacement items for each customizable storyboard item are prepared in the state 906. For an example, substitute symbols and item information for replacements of the top hat, such as a baseball cap, a hard hat and a bicycle helmet, are generated. Then in a stats 908, all animation pre-production items, as described in FIG. 7, including all fixed storyboard items, customizable storyboard items and replacements, are generated. The process then go to a state 910, where a graphical user interface is prepared, featuring the storyboards with customizable storyboard items. Examples of the user interface are shown in FIG. 2 to FIG. 6. Now the platform is ready to be used by a client.

Next, the process goes to a state 912, where the platform receives a request by a customer to initiate an interactive session to use the graphical user interface. Once the request is received, the process goes to a state 914 where the graphical user interface is sent to an interactive device 140, or to a mobile interactive device 150, used by the customer to access the platform, and then to a state 916 where the user data 146, containing video/audio data 124, custom arts 126 and user selections 128 are received from the interactive device 140, or from the mobile interactive device 150. The use selection 128 includes, for instance, information indicating which one of the replacement storyboard items 403a was selected by the user. In the session, the customer interacts with the user interface to customize storyboards to one's liking, as described in FIGS. 2-6. Then, the process goes to a state 918, where a determination is made as to whether the customer wants to create an animation. Upon positive answer, the process goes to a state 920, where the requested animation is generated, with the process described in FIG. 8. The process then goes to a state 922 to send the generated animation to the customer, and subsequently the process goes to a state 924. In the state 924, a determination is made to whether the interactive session has ended. Upon negative answer, the process goes to the state 914 to continue the session. Upon positive answer, the process terminates at a state 926. In the state 918, upon the negative answer, the process goes to the state 924.

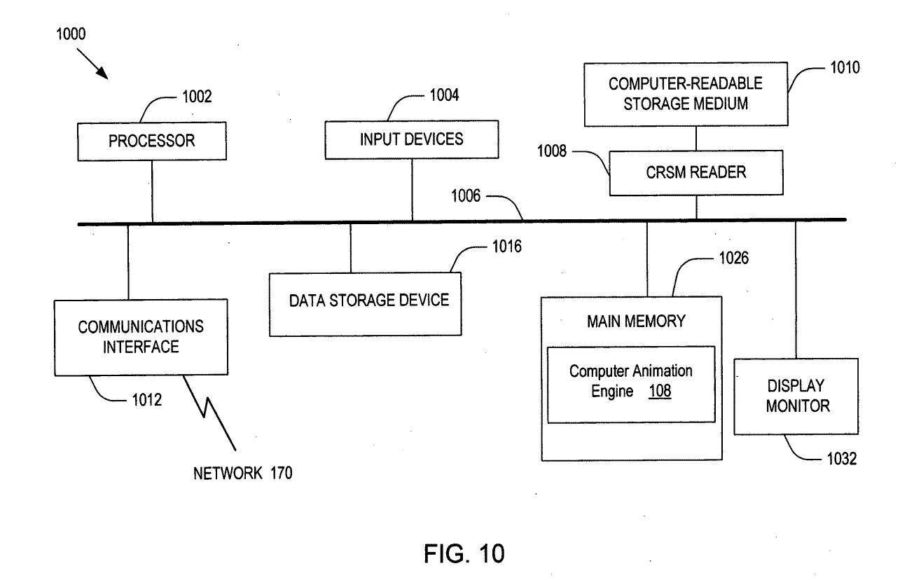

FIG. 10 shows an embodiment of a computer 1000 of a type that might be employed as the custom animation platform 102 in accordance with the present invention. The computer 1000 may have less or more components to meet the needs of a particular application. As shown in FIG. 10, the computer may include one or more processors 1002 including CPUs. The computer may have one or more buses 1006 coupling its various components. The computer may also include one or more input devices 1004 (e.g., keyboard, mouse, joystick), a computer-readable storage medium (CRSM) 1010, a CRSM reader 1008 (e.g., floppy drive, CD-ROM drive), a communication interface 1012 (e.g., network adapter, modem) for coupling to the network 170, one or more data storage devices 1016 (e.g., hard disk drive, optical drive, FLASH memory), a main memory 1026 (e.g., RAM) containing. software embodiments, such as the computer animation engine 108, and one or more monitors 1032. Various softwares may be stored in the computer-readable storage medium 1010 for reading into a data storage device 1016 or main memory 1026.

While the invention has been described in detail with reference to specific embodiments thereof, it will be apparent to those skilled in the art that various changes and modifications can be made, and equivalents employed, without departing from the scope of the appended claims.

What is claimed is:

1. A method for customizing a computer animation, comprising:
preparing a storyboard including at least one customizable storyboard item;
preparing one or more replacement storyboard items configured to replace the customizable storyboard item;
sending the storyboard and the replacement storyboard items to a device via a network to thereby cause a user of the device to select one of the replacement storyboard items;
receiving user data including the user's selection from the device; and
causing a computer processor to generate a computer animation based on the user data.

2. A method as recited in claim 1, further comprising:
sending a substitute symbol and item information for each of the replacement storyboard items to the device.

3. A method as recited in claim 1, wherein the network is Internet and the user interface is a Hyper Text Markup Language script.

4. A method as recited in claim 1, further comprising:
receiving a request to generate the computer animation from the device; and
sending the computer animation to the device.

5. A method as recited in claim 1, wherein the step of sending includes sending information of a user interface featuring the storyboard to the device.

6. A method as recited in claim 1, wherein the user data includes at least one of video data, audio data, and custom arts.

7. A method as recited in claim 1, wherein the step of causing includes:
preparing pre-production items;
selecting one or more of the pre-production items to reflect the user data; and
generating the computer animation with the selected pre-production items.

8. A method as recited in claim 7, further comprising, prior to the step of generating the computer animation:
transfiguring the selected pre-production items.

9. A method as recited in claim 6, wherein the user data further includes a custom dialog to be included in the computer animation.

10. A method as recited in claim 1, further comprising:
receiving information of an advertisement to be included in the computer animation from the device; and
incorporating the advertisement into the computer animation.

11. A method as recited in claim 10, wherein the advertisement is incorporated as at least one of a product placement, a trademark placement, a virtual billboard, a hypertext link, and an animation.

12. A method as recited in claim 1, wherein the step of causing includes causing one or more additional processor to render the computer animation.

13. A method for generating a computer animation via network, comprising:
receiving at least one user interface that includes a storyboard having at least one customizable storyboard item via network;
displaying the user interface on a display;
displaying one or more replacement storyboard items configured to replace the customizable storyboard item on the display;
causing a user to select one of the replacement storyboard items;
sending user data including the user's selection;
sending a request to generate a computer animation based on the user data; and
receiving and displaying the computer animation on the display.

14. A method as recited in claim 13, wherein the user data includes at least one of video data, audio data, custom arts, and a custom dialog to be included in the computer animation.

15. A method as recited in claim 13, further comprising:
sending information of an advertisement to be included in the computer animation.

16. A method as recited in claim 13, further comprising, prior to the step of displaying one or more replacement storyboard items:
receiving the replacement storyboard items via the network.

17. A method as recited in claim 13, further comprising, prior to the step of displaying one or more replacement storyboard items:
causing the user to provide the replacement storyboard items.

18. A computer readable medium storing one or more sequences of pattern data for customizing a computer animation, wherein execution of one or more sequences of pattern data by one or more processors causes the one or more processors to perform the steps of:
preparing a storyboard including at least one customizable storyboard item;
preparing one or more replacement storyboard items configured to replace the customizable storyboard item;
sending the storyboard and the replacement storyboard items to a device via a network to thereby cause a user of the device to select one of the replacement storyboard items;
receiving user data including the user's selection from the device; and
generating a computer animation based on the user data.

19. A computer readable medium as recited in claim 18, wherein the step of sending includes sending a substitute symbol and item information for each of the replacement storyboard items to the device.

20. A computer readable medium as recited in claim 18, wherein execution of one or more sequences of pattern data by one or more processors causes the one or more processors to perform the additional steps of:
receiving a request to generate the computer animation from the device; and
sending the computer animation to the device.

21. A computer readable medium as recited in claim 18, wherein the step of sending includes sending information of a user interface featuring the storyboard to the device.

22. A computer readable medium as recited in claim 18, wherein the user data includes at least one of video data, audio data, custom arts, and custom dialog to be included in the computer animation.

23. A computer readable medium as recited in claim 18, wherein the step of generating a computer animation includes:
preparing pre-production items;
selecting one or more of the pre-production items to reflect the user data; and
generating the computer animation with the selected pre-production items.

24. A computer readable medium as recited in claim 23, wherein execution of one or more sequences of pattern data by one or more processors causes the one or more processors to perform the additional step of, prior to the step of generating the computer animation with the selected pre-production items:
transfiguring the selected pre-production items.

25. A computer readable medium as recited in claim 18, wherein execution of one or more sequences of pattern data by one or more processors causes the one or more processors to perform the additional steps of:
receiving information of an advertisement to be included in the computer animation from the device; and
incorporating the advertisement into the computer animation.

26. A computer readable medium storing one or more sequences of pattern data for generating a computer animation via network, wherein execution of one or more sequences of pattern data by one or more processors causes the one or more processors to perform the steps of:
receiving at least one user interface that includes a storyboard having at least one customizable storyboard item via network;
displaying the user interface on a display;
displaying one or more replacement storyboard items configured to replace the customizable storyboard item on the display;
causing a user to select one of the replacement storyboard items;
sending user data including the user's selection;
sending a request to generate a computer animation based on the user data; and
receiving and displaying the computer animation on the display.

27. A computer readable medium as recited in claim 26, wherein the user data includes at least one of video data, audio data, custom arts, and a custom dialog to be included in the computer animation.

28. A computer system, comprising:
a custom animation platform adapted to:
prepare a storyboard including at least one customizable storyboard item;
prepare one or more replacement storyboard items configured to replace the customizable storyboard item;
send the storyboard and the replacement storyboard items to a device via a network to thereby cause a user of the device to select one of the replacement storyboard items;
receive, from the device, user data including the replacement story board item selected by the user; and
generate a computer animation based on the user data.

29. A computer system as recited in claim 28, wherein the custom animation platform is further adapted to send a substitute symbol and item information for each of the replacement storyboard items to the device.

30. A computer system as recited in claim 28, wherein the custom animation platform is further adapted to receive a request to generate the computer animation from the device and send the computer animation to the device.

31. A computer system as recited in claim 28, wherein the custom animation platform is further adapted to send information of a user interface featuring the storyboard to the device.

32. A computer system as recited in claim 28, wherein the user data includes at least one of video data, audio data, custom arts, and custom dialog to be included in the computer animation.

33. A computer system as recited in claim 28, wherein the custom animation platform is further adapted to:
prepare pre-production items;
select one or more of the pre-production items to reflect the user data; and
generate the computer animation with the selected pre-production items.

34. A computer system as recited in claim 33, wherein the custom animation platform is further adapted to transfigure the selected pre-production items.

35. A computer system as recited in claim 28, wherein the custom animation platform is further adapted to receive information of an advertisement to be included in the computer animation from the device and incorporate the advertisement into the computer animation.

36. A computer system, comprising:
a processor adapted to receive at least one user interface that includes a storyboard having at least one customizable storyboard item via a network; and
a display for displaying the user interface and one or more replacement storyboard items configured to replace the customizable storyboard item,
wherein the processor is further adapted to cause the user to select one of the replacement storyboard items, send user data including the user's selection, send a request to generate a computer animation based on the user data, and receive the computer animation and wherein the display is further adapted to display the computer animation.

37. A computer system as recited in claim 36, wherein the user data includes at least one of video data, audio data, custom arts, and a custom dialog to be included in the computer animation.
